(19) United States
(12) Patent Application Publication
(10) Pub. No.: US 2024/0283025 A1
(43) Pub. Date: Aug. 22, 2024

(54) Electrolyte Solution for Lithium Metal Battery, Method for Preparing the Same and Lithium Metal Battery Comprising the Same

(71) Applicant: Academia Sinica, Taipei City (TW)

(72) Inventors: Maw-Kuen WU, Taipei City (TW); Feng-Yu WU, Taipei City (TW); Po-Wei CHI, Taipei City (TW); Phillip M WU, Taipei City (TW)

(21) Appl. No.: 18/582,913

(22) Filed: Feb. 21, 2024

Related U.S. Application Data
(60) Provisional application No. 63/486,313, filed on Feb. 22, 2023.

(51) Int. Cl. H01M 10/0567; H01M 4/36; H01M 4/38; H01M 4/583; H01M 10/052; H01M 10/0568; H01M 10/0569

(52) U.S. Cl. CPC H01M 10/0567; H01M 4/362; H01M 4/382; H01M 4/583; H01M 10/052; H01M 10/0568; H01M 10/0569; H01M 2300/0037

(57) ABSTRACT

Disclosed is an electrolyte solution for a lithium metal battery, comprising: a lithium thiophosphate complex formed by phosphorus pentasulfide and lithium polysulfide. In addition, a lithium metal battery comprising the aforesaid electrolyte solution and a method for preparing the aforesaid electrolyte solution are also disclosed.

### CROSS-REFERENCE TO RELATED APPLICATIONS

This application claims the benefit of filing date of U.S. Provisional Application Ser. No. 63/486,313, filed Feb. 22, 2023 under 35 USC § 119(e)(1).

### BACKGROUND OF THE INVENTION

### Field

The present invention provides an electrolyte solution for a lithium metal battery, a method for preparing the same and a lithium metal battery comprising the same. In particular, the present invention provides an electrolyte solution for a lithium-sulfur battery, a method for preparing the same and a lithium metal battery comprising the same.

### Description of Related Art

Lithium metal batteries are positioned to revolutionize the landscape of lithium-ion batteries. Beyond the lithium metal batteries, lithium-oxygen and lithium-sulfur batteries system attract widespread attention because it undergoes multiphase redox reactions in whole charge-discharge cycle. As a known cathode material, elemental sulfur is abundant, inexpensive, and nontoxic; it also possesses a high capacity, heightened output current density, and superior of energy density. By pairing Lithium to elemental sulfur, lithium-sulfur batteries can deliver an impressive theoretical capacity up to 1675 mAh/g—a remarkable tenfold increase compared to traditional lithium-ion batteries systems (NCM). The theoretical energy density is equally noteworthy at 2500 Wh/kg, surpassing the conventional lithium-ion batteries by 4 to 5 times.

Despite these promising attributes, the employment of lithium metal as the anode remains challenge, including poor cycle stability and a limited lifespan, which significantly impedes their commercial adoption.

In essence, the present invention aspires to pave the way for overcoming limitations that have hindered the feasibility of lithium-sulfur batteries in scale-up applications.

### SUMMARY OF THE INVENTION

Owing to the inherently lightweight nature of sulfur and lithium elements, lithium-sulfur batteries have emerged as a highly promising and crucial option in the pursuit of high-capacity batteries. However, despite their potential, significant drawbacks, including capacity fading and poor stability, have limited their widespread commercial applications. The present invention addresses these challenges by incorporating electrolyte additives to establish a lithium-sulfur batteries system characterized by enhanced cycle stability and prolonged capacity retention.

The present invention provides an electrolyte solution for a lithium metal battery, which comprises: a lithium thiophosphate complex formed by phosphorus pentasulfide and lithium polysulfide. Herein, the lithium metal battery is preferably a lithium-sulfur battery.

In the present invention, a molar ratio of the phosphorus pentasulfide and the lithium polysulfide in the lithium thiophosphate complex may range from 1:1 to 1:3. When the molar ratio of the phosphorus pentasulfide and the lithium polysulfide is out of aforesaid range, the solubility of the lithium thiophosphate complex is not good.

In the present invention, the lithium thiophosphate complex may be represented by the following formula (I):

XLi-YS-ZP (I)

wherein X is 0.8 to 1.2, Y is 3 to 5.5, and Z is 0.3 to 0.5. When X, Y and/or Z is out of the aforesaid range, the solubility of the lithium thiophosphate complex is not good.

In the present invention, the electrolyte solution may further comprise P₂S₅, Li₂S or a combination thereof.

In the present invention, the electrolyte solution may further comprise a solvent comprising DOL (1,3-dioxolane) and a glyme-based solvent. Examples of the glyme-based solvent may include, but are not limited to DME (1,2-dimethoxyethane), TEGDME (tetraethylene glycol dimethyl ether), DEGDME (diethylene glycol dimethyl ether) or a combination thereof. Herein, the volume ratio of DOL to the glyme-based solvent may range from 1:5 to 5:1, 1:4 to 4:1, 1:3 to 3:1 or 1:2 to 2:1. In one embodiment, the volume ratio of DOL to the glyme-based solvent may be about 1:1.

In the present invention, a concentration of phosphorus pentasulfide in the electrolyte solution may be 0.5 M to 2.0 M. In one embodiment, the concentration of phosphorus pentasulfide in the electrolyte solution is 0.5 M to 1.5 M. In one embodiment, the concentration of phosphorus pentasulfide in the electrolyte solution is 0.5 M to 1.0 M. In one embodiment, the concentration of phosphorus pentasulfide in the electrolyte solution is about 0.75 M.

In the present invention, the electrolyte solution does not comprise other electrolyte salt. More specifically, the aforesaid lithium thiophosphate complex is used to replace the conventional electrolyte salts such as lithium salts (for example, LiTFSI or other lithium salts known in the art).

In the present invention, the electrolyte solution may further comprise LiNO₃. Herein, the adding amount of LiNO₃ in the electrolyte solution is very little. For example, in one embodiment, a concentration of LiNO₃ in the electrolyte solution may be 1 wt % to 5 wt %. In one embodiment, the concentration of LiNO₃ in the electrolyte solution may be 1 wt % to 4 wt %. In one embodiment, the concentration of LiNO₃ in the electrolyte solution may be 1 wt % to 3 wt %. In the present invention, the adding amount of LiNO₃ in the electrolyte solution is very little, so LiNO₃ is not used as the electrolyte salts, but is used as a reducing agent facilitating the formation of the solid-electrolyte interface layer (SEI).

Moreover, the present invention further provides a lithium metal battery, which comprises: a first electrode; a second electrode disposed opposite to the first electrode; and the aforesaid electrolyte solution disposed between the first electrode and the second electrode. Herein, the lithium metal battery is preferably a lithium-sulfur battery.

In the present invention, the first electrode may a Li electrode. In the present invention, the second electrode is a sulfur-carbon composite electrode. The sulfur-carbon composite electrode may comprise sulfur and carbon (for example, conductive carbon). The weight ratio of sulfur to carbon may range from 9:1 to 1:1, 8:1 to 1:1, 7:1 to 1:1, 6:1 to 1:1, 5:1 to 1:1, 4:1 to 1:1, 4:1 to 2:1 or 4:1 to 3:1. The sulfur-carbon composite electrode may further comprise a binding agent (for example, pectin). The adding amount of the binding agent may be 1 wt % to 20 wt % based on the total weight of the sulfur-carbon composite electrode.

The present invention entails the development of a novel electrolyte system for lithium-sulfur batteries. This involves the addition of phosphorus-containing additives and the incorporation of a lithium polysulfide reaction-derived electrolyte matrix, utilizing alternative lithium salts as electrolytes. Furthermore, lithium nitrate is introduced as the solid-electrolyte interface layer (SEI) reducing agent in the reaction. This unique combination allows the electrolyte to undergo a reaction with metallic lithium, resulting in the formation of a multi-functional solid-electrolyte interface layer. Simultaneously, this process inhibits the formation of surface dendrites, enhancing lithium utilizing efficiency. The final results indicating a remarkable improvement in the cycle stability and capacity retention of the lithium-sulfur batteries system, thereby facilitating enhanced performance across various charge and discharge rates.

Moreover, the present invention further provides a method for preparing the aforesaid electrolyte solution, which comprises the following steps: providing a lithium polysulfide solution; adding phosphorus pentasulfide into the lithium polysulfide solution, followed by heating and stirring to form the aforesaid electrolyte solution. Herein, the phosphorus pentasulfide and the lithium polysulfide are reacted to form the aforesaid lithium polysulfide by heating and stirring for a period of time. The heating temperature may range from 60° C. to 100° C., 60° C. to 90° C. or 60° C. to 80° C. In one embodiment, the heating temperature may be about 70° C.

In the present invention, the lithium polysulfide solution may be prepared by the following steps: adding Li₂S and S powders into a solvent, followed by heating and stirring to form the lithium polysulfide solution. Herein, the Li₂S and S powders are reacted to form the lithium polysulfide by heating and stirring for a period of time. The heating temperature may range from 60° C. to 100° C., 60° C. to 90° C. or 60° C. to 80° C. In one embodiment, the heating temperature may be about 70° C.

In the present invention, the solvent used in the lithium polysulfide solution may comprise DOL and a glyme-based solvent. Examples of the glyme-based solvent may include, but are not limited to DME, TEGDME, DEGDME or a combination thereof. Herein, the volume ratio of DOL to the glyme-based solvent may range from 1:5 to 5:1, 1:4 to 4:1, 1:3 to 3:1 or 1:2 to 2:1. In one embodiment, the volume ratio of DOL to the glyme-based solvent may be about 1:1.

Other novel features of the disclosure will become more apparent from the following detailed description when taken in conjunction with the accompanying drawings.

### BRIEF DESCRIPTION OF DRAWINGS

FIG. 1A and FIG. 1B are diagrams respectively showing the results of the EIS (electrochemical impedance spectroscopy) analysis of a symmetry cell before and after cycling.

FIG. 2 is a diagram showing the results of the Li plating/stripping test for a symmetry cell using traditional electrolyte (LiTFSI) and the electrolyte of the present invention (S6) at a current density of 1 mA/cm² with a capacity of 1 mAh/cm².

FIG. 3 is a diagram showing the electrochemical property of the electrolyte of the present invention.

FIG. 4A and FIG. 4B are diagrams showing the life cycle test results for the electrolyte of the present invention.

FIG. 5 is a diagram showing the life cycle test results for the electrolyte of the present invention under an operating voltage range of 1.5-3 V and a current density of 0.1° C. for charge and discharge steps.

FIG. 6 shows the SEM images illustrating the lithium metal surface before cycling.

FIG. 7 shows the SEM images illustrating the lithium metal surface after cycling.

### DETAILED DESCRIPTION OF THE INVENTION

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the element, except otherwise specified.

Moreover, in the present specification, the ordinal numbers, such as “first” or “second”, are used to distinguish a plurality of elements having the same name, and it does not means that there is essentially a level, a rank, an executing order, or an manufacturing order among the elements, except otherwise specified. A “first” element and a “second” element may exist together in the same component, or alternatively, they may exist in different components, respectively. The existence of an element described by a greater ordinal number does not essentially means the existent of another element described by a smaller ordinal number.

Moreover, in the present specification, the terms, such as “top”, “bottom”, “left”, “right”, “front”, “back”, or “middle”, as well as the terms, such as “on”, “above”, “under”, “below”, or “between”, are used to describe the relative positions among a plurality of elements, and the described relative positions may be interpreted to include their translation, rotation, or reflection.

Moreover, in the present specification, when an element is described to be arranged “on” another element, it does not essentially means that the elements contact the other element, except otherwise specified. Such interpretation is applied to other cases similar to the case of “on”.

Moreover, in the present specification, a value may be interpreted to cover a range within ±10% of the value, and in particular, a range within ±5% of the value, except otherwise specified; a range may be interpreted to be composed of a plurality of subranges defined by a smaller endpoint, a smaller quartile, a median, a greater quartile, and a greater endpoint, except otherwise specified.

The present invention capitalizes on the reaction between phosphorus pentasulfide and lithium polysulfide to form the electrolyte system matrix. Various electrolytes are prepared in different ratios of electrolyte components. The patent systematically conducts electrochemical analyzes on the prepared electrolytes, characterizing their properties before and after charging and discharging step. Additionally, comprehensive tests are conducted to evaluate the performance of lithium-sulfur batteries with the proposed electrolyte systems.

In the following embodiments, the lithium thiophosphate complexes were prepared according to the formulations shown in the following Table 1.

TABLE 1

| | Components | XLi—YS—ZP | | |
|---|---|---|---|---|
| Formulation | Molar ratio | X (Li) | Y (S) | Z (P) |
| S6 | Li₂S:P₂S₅:S₈ | 1 | 3 | 0.43 |
| | 0.56:0.24:0.20 | | | |
| S8 | Li₂S:P₂S₅:S₈ | 1 | 4 | 0.43 |
| | 0.49:0.21:0.30 | | | |
| S10 | Li₂S:P₂S₅:S₈ | 1 | 5.14 | 0.44 |
| | 0.43:0.19:0.38 | | | |

### Preparation of Lithium Polysulfides

Lithium polysulfides, Li₂Sₓ (3≤x≤9), were prepared by stirring stoichiometric Li₂S and S powders (>99% trace metals basis, Sigma-Aldrich) in the mixtures of DME (≥98%, Sigma-Aldrich), DOL (≥99%, Sigma-Aldrich) solvent in 1:1 (v/v) ratio at 70° C. for 12 hours in an Argon-filled glovebox (O₂<0.2 ppm, H₂O<0.1 ppm, vigor USA)

### Preparation of Lithium Thiophosphate Complexes

To prepare lithium thiophosphate (mP₂S₅-nLi₂Sₓ) complexes in DME and DOL mixed solution, a stoichiometric amount of P₂S₅(≥99%, Sigma-Aldrich) was added to the as-prepared Li₂Sₓ solutions and stirred at 70° C. for 5 hours. The characteristic light yellow to dark red appearance of the complexes can be observed after stirring.

### Preparation of Li—P—S Electrolyte

mP₂S₅-nLi₂Sₓ complexes, and/or Li₂Sₓ solution were added into DME and DOL mixture solution (DME:DOL=1:1 (v/v)) as electrolytes. In addition, 3 wt % LiNO₃ (99.99% trace metals basis, Sigma-Aldrich) powder were dissolved into the DME and DOL mixture solution. The P₂S₅ concentrations were kept as 0.75 M in all electrolyte solutions as the baseline. Lithium thiophosphate complexes in the mixture of DOL with other glyme-based solvent can be prepared in a similar method.

### Preparation of Blank Electrolyte Solutions

1.0 M LiTFSI (99.95% trace metals basis, Sigma-Aldrich), and 3 wt % LiNO₃ (99.99% trace metals basis, Sigma-Aldrich) powder were dissolved into the DME and DOL mixture solution (1:1 (v/v)) and stirred at room temperature in glove box for 3 hours.

### Sulfur Cathode Preparation

To fabricate the sulfur cathode, 70 wt % of Sulfur powder (≥99.0%, Sigma-Aldrich) was dry mixed with 20 wt % of super P carbon black (Denka, 50% compressed) and 10 wt % of pectin (pectin from apple, Sigma-Aldrich) powder, and following by dispersing in DI water of 1700 rpm at ambient environment for slurry fabricating. After 3 hours stirring, and process by casting, drying and rolling, the cathode pieces were punched into 14 mm discs and ready for coin cell assembling.

### Coin Cell Assembly and Measuring

CR2032 coin cells (Ubiq Co.; Taiwan) were assembled inside an argon-filled glove box (Vigor.; USA). Besides, using the cathode discs pre-dried at 120° C. in vacuum. For half-cells, the diameter of lithium-metal anode (Ø15.8 mm) and separator (Asahi co. Japan) were pre-rinsed by electrolyte solution (uptake ˜25 μL) before cell assembling. The cell assembled with a fixed amount of electrolyte (15 μL) was dropped onto a sulfur cathode disc.

The electrolyte was introduced into a symmetric cell consisting of two metallic lithium foils for electrochemical impedance spectroscopy analysis. The objective was to monitor changes in ionic impedance at the interface between the electrolyte and lithium before and after cycles.

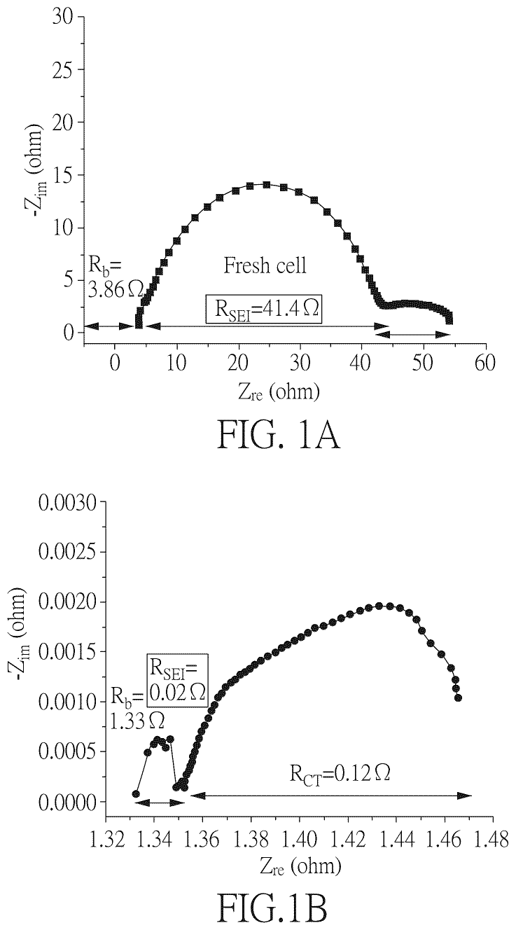

FIG. 1A and FIG. 1B are diagrams respectively showing the results of the EIS (electrochemical impedance spectroscopy) analysis of a symmetry cell before and after cycling. Herein, the electrolyte, S6, was used. In FIG. 1A and FIG. 1B, R_{b} represents bulk resistance and R_{CT} represents charge-transfer resistance.

The results reveal a substantial reduction in interface impedance as the number of cycle increases. The impedance value, initially around 41.4Ω (FIG. 1A), significantly drops to 0.12Ω after 200 cycles (FIG. 1B). This observation underscores the key role played by the solid-electrolyte interface layer formed during charge and discharge cycles in mitigating lithium-ion impedance.

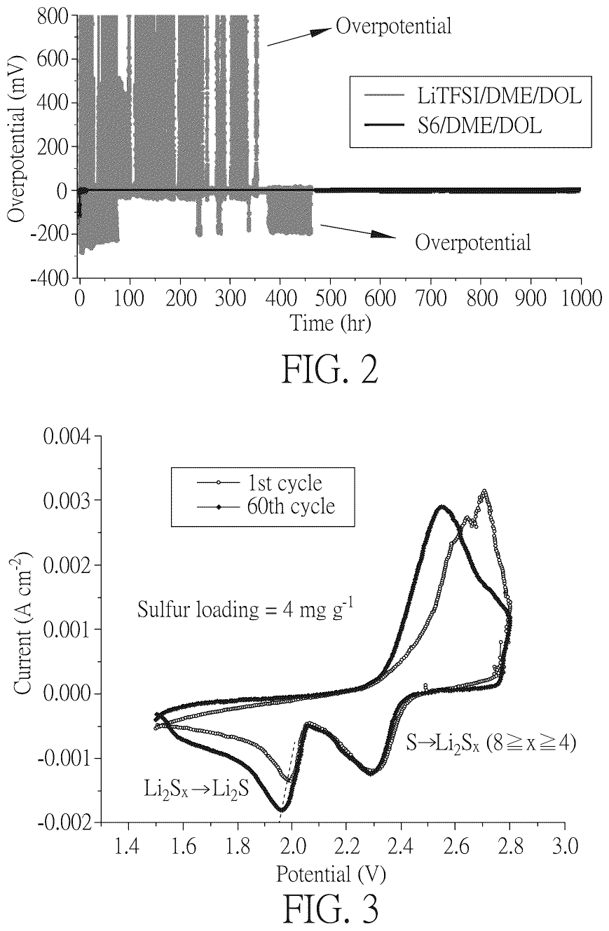

FIG. 2 is a diagram showing the results of the Li plating/stripping test for a symmetry cell using traditional electrolyte (LiTFSI) and the electrolyte of the present invention (S6) at a current density of 1 mA/cm² with a capacity of 1 mAh/cm².

In FIG. 2, the outcomes of a life cycle test are displayed, wherein continuous Li plating/stripping was conducted in a symmetry cell at a current density of 1 mA/cm² for 1 hour. The objective of this test was to assess the impact of the proposed electrolyte on inhibiting dendrite growth. Notably, over the course of the 400-hour continuous cycle, the overpotential of the cell remains stable. Importantly, there is no discernible dendritic growth, peeling, or separator puncture observed, ensuring the integrity of the battery and preventing short-circuits.

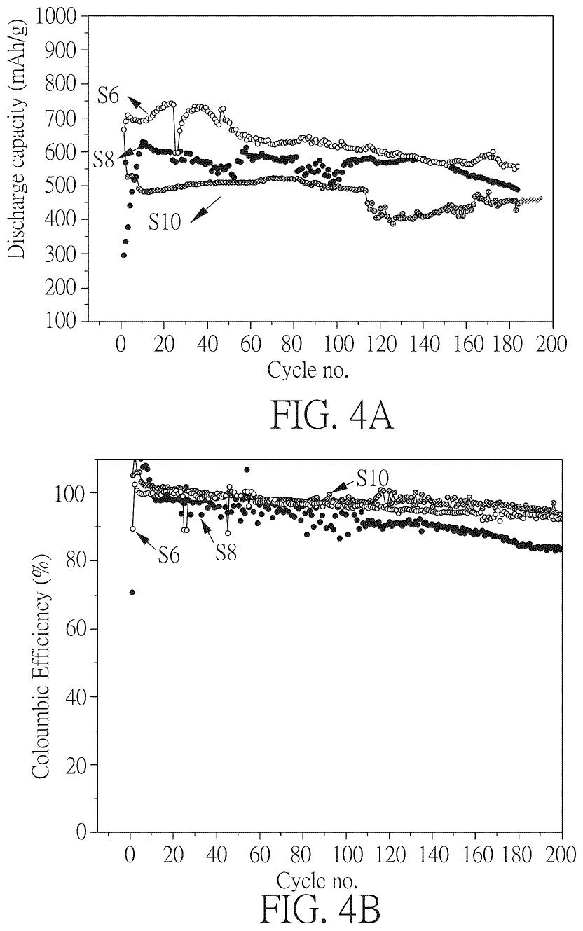

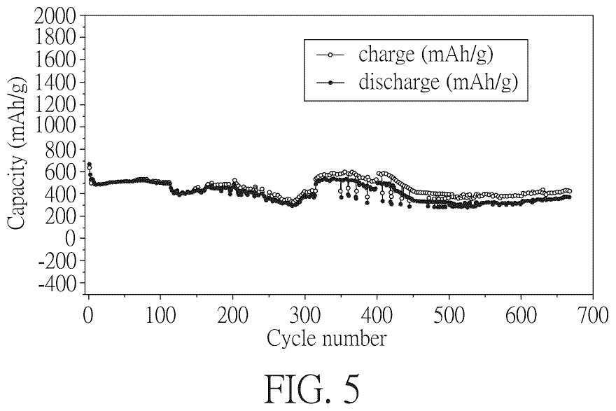

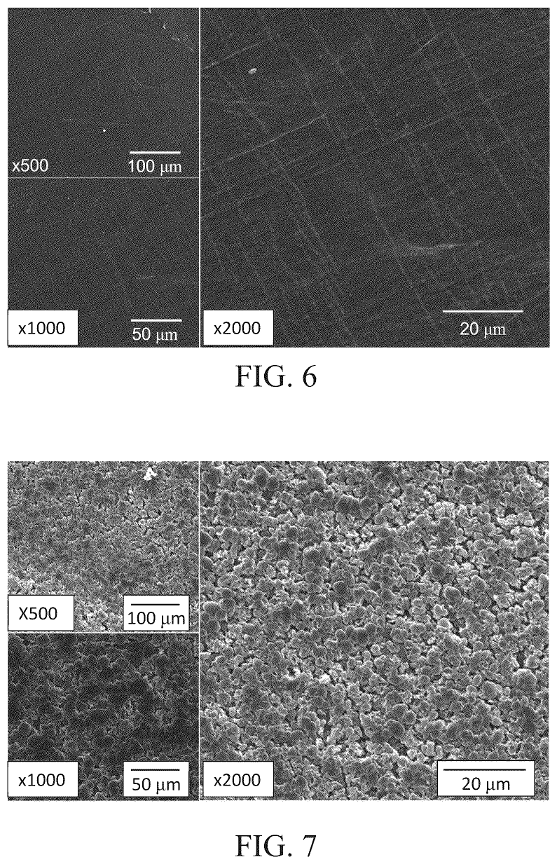

To further assess the performance of the designed electrolyte in lithium-sulfur batteries, in the following experiments, the study employed lithium metal as the anode and combine with sulfur and conductive carbon as the cathode. Except for the experiments of FIG. 4A and FIG. 4B, the electrolyte S6 was used in the experiments of FIG. 3, FIG. 5, FIG. 6 and FIG. 7.

FIG. 3 shows the results of electrochemical performance testing conducted by the lithium-sulfur batteries. The discharge reaction potentials are 2.3 V and 1.98 V, which are the sulfur ring opening and Li₂—Sₓ chain length changes during the charge and discharge process. The charging peak center is located at 2.7 V. After multiple charge-discharge cycles, the low-voltage discharge peak potential shifted slightly to 1.96 V, the area gradually became larger and stabilized, and the charging peak shifted to 2.5 V. Cyclic voltammetry analysis highlights reversible oxidation and reduction peaks through charge-discharge cycles, indicative of a stable potential range. This suggests the suitability of the electrolyte for facilitating consistent and reversible electrochemical reactions in the lithium-sulfur battery system, and no side effect occurred when using the electrolyte of the present invention.

FIG. 4A and FIG. 4B are diagrams showing the life cycle test results for the electrolyte of the present invention, wherein the outcomes of life cycle testing for a lithium-sulfur batteries are presented, conducted under an operating voltage range of 1.7-2.8V and a current density of 0.1° C. for charge and discharge steps. The initial cycles exhibit an enhancement in both charge and discharge capacity, and stabilizing at 630 mAh/g. Over the course of more than 1500 hours and 200 cycles, the capacity gradually diminishes to 480 mAh/g. This demonstrates the acceptable stability of lithium-sulfur batteries operation over an extended period, characterized by a smooth decline in capacity instead of severe fluctuations.

FIG. 5 is a diagram showing the life cycle test results for the electrolyte of the present invention under an operating voltage range of 1.5-3 V and a current density of 0.1° C. for charge and discharge steps. This demonstrates the acceptable stability of lithium-sulfur batteries operation over an extended period.

To evaluate the effectiveness of dendrite suppression by the designed electrolyte, scanning electron microscope (SEM) was employed for surface morphology observation of the lithium metal surface of the lithium-sulfur batteries.

FIG. 6 displays the lithium metal surface before cycling, exhibiting a smooth surface without marked defects. FIG. 7 shows the lithium metal surface image after cycling, revealing the formation of a homogeneous solid-liquid interface layer (SEI) with thickness of several micrometers. Notably, no dendritic structure was observed on the lithium metal surface, in the contrary, a SEI layer with a sponge-liked 3D structure covered on lithium metal surface. This observation confirms that, following with galvanostatic cycling, a robust solid-electrolyte interface layer can form on the lithium metal surface. This layer serves as a shield for underlying lithium metal, effectively inhibiting dendrite growth and thereby increasing the contacting area of lithium and electrolyte which promoting the performance of lithium sulfur batteries.

In conclusion, by employing the concept of artificially-induced solid electrolyte interface (SEI), result of this proposal shows dendrites inhibited Li surface. The innovative solution not only augments safety but also contributes to enhanced cycling performance. Moreover, the development of the solid-electrolyte interface holds promise in mitigating ion conductivity issues associated with the elemental sulfur cathode. This breakthrough is anticipated to improve the columbic efficiency of sulfur cathode, also optimizing the sluggish chemistry which occurred at the end of discharge step.

Although the present disclosure has been explained in relation to its embodiment, it is to be understood that many other possible modifications and variations can be made without departing from the spirit and scope of the disclosure as hereinafter claimed.

1. An electrolyte solution for a lithium metal battery, comprising:
a lithium thiophosphate complex formed by phosphorus pentasulfide and lithium polysulfide.

2. The electrolyte solution of claim 1, wherein a molar ratio of the phosphorus pentasulfide and the lithium polysulfide in the lithium thiophosphate complex ranges from 1:1 to 1:3.

3. The electrolyte solution of claim 1, wherein the lithium thiophosphate complex is represented by the following formula (I):
XLi—YS-ZP (I)
wherein X is 0.8 to 1.2, Y is 3 to 5.5, and Z is 0.3 to 0.5.

4. The electrolyte solution of claim 1, wherein a concentration of phosphorus pentasulfide in the electrolyte solution is 0.5 M to 2.0 M.

5. The electrolyte solution of claim 1, further comprising P₂S₅, Li₂S or a combination thereof.

6. The electrolyte solution of claim 1, further comprising LiNO₃.

7. The electrolyte solution of claim 6, wherein a concentration of LiNO₃ in the electrolyte solution is 1 wt % to 5 wt %.

8. The electrolyte solution of claim 1, further comprising a solvent comprising DOL and a glyme-based solvent.

9. The electrolyte solution of claim 8, wherein the glyme-based solvent is DME, TEGDME, DEGDME or a combination thereof.

10. The electrolyte solution of claim 1, wherein the lithium metal battery is a lithium-sulfur battery.

11. The electrolyte solution of claim 1, wherein the electrolyte solution does not comprise other electrolyte salt.

12. A lithium metal battery, comprising:
a first electrode;
a second electrode disposed opposite to the first electrode; and
an electrolyte solution of claim 1 disposed between the first electrode and the second electrode.

13. The lithium metal battery of claim 12, wherein the lithium metal battery is a lithium-sulfur battery.

14. The lithium metal battery of claim 12, wherein the first electrode is a Li electrode.

15. The lithium metal battery of claim 12, wherein the second electrode is a sulfur-carbon composite electrode.

16. The lithium metal battery of claim 15, wherein the sulfur-carbon composite electrode comprises conductive carbon.

17. A method for preparing an electrolyte solution of claim 1, comprising the following steps:
providing a lithium polysulfide solution;
adding phosphorus pentasulfide into the lithium polysulfide solution, followed by heating and stirring to form the electrolyte solution of claim 1.

18. The method of claim 17, wherein the lithium polysulfide solution is prepared by the following steps:
adding Li₂S and S powders into a solvent, followed by heating and stirring to form the lithium polysulfide solution.

19. The method of claim 18, wherein the solvent comprises DOL and a glyme-based solvent.

20. The method of claim 19, wherein the glyme-based solvent is DME, TEGDME, DEGDME or a combination thereof.
